(19) United States
(12) Patent Application Publication
(10) Pub. No.: US 2026/0267332 A1
(43) Pub. Date: Sep. 10, 2026

(54) ROBOTIC VEHICLE

(71) Applicant: Ocado Innovation Limited, Hatfield (GB)

(72) Inventors: Dimitri Nikitopoulos, Boston, MA (US); Daniel Grieneisen, Watertown, MA (US)

(21) Appl. No.: 19/075,254

(22) Filed: Mar. 10, 2025

(51) Int. Cl. G05D 1/227; B66F 9/06; B66F 9/075; G05D 1/224; G05D 109/10

(52) U.S. Cl. CPC G05D 1/227; B66F 9/063; B66F 9/0755; G05D 1/2247; G05D 2109/10

(57) ABSTRACT

A robotic vehicle is disclosed which can operate in an autonomous mode. The robotic vehicle may be switched into an assisted drive mode, for example by the activation of a handle. When the robotic vehicle is in the assisted drive mode then images from one or more cameras comprised within the robotic vehicle may be displayed on a robotic vehicle display screen.

### FIELD OF THE DISCLOSURE

This disclosure relates generally to robots and, more particularly, to apparatus, systems, and methods for operating robots in an assisted drive mode.

### BACKGROUND

During operation, a robot may move autonomously in an environment in response to, for instance, instructions generated based on user inputs. In some instances, such as for maintenance purposes, a user may manually move the robot by exerting force on the robot.

FIG. 1 shows a schematic depiction of a robotic vehicle 100. The robotic vehicle 100 comprises a body 120 in which are housed multiple components used in the operation of the vehicle, for example control electronics, a drive module which can be controlled by the control electronics to control the movement of the robotic vehicle and other actions of the robotic vehicle. Attached to the body 120 is a display screen 122 such that information relating to the operation of the robotic vehicle and/or one or more tasks which are to be completed in conjunction with the robotic vehicle.

The robotic vehicle further comprises a platform support area 130 which is located at the rear of the robotic vehicle. The robotic vehicle further comprises a lifting shuttle 136 which is coupled to a first fork 132 and second fork 134. In operation, the lifting shuttle can be advanced from the body of the robotic vehicle, such that the first fork 132 and the second fork 134 are advanced from underneath the platform support area 130. The first fork and the second fork may be inserted into the interior of a platform (for example a pallet) such that that the platform may be lifted from the surface in which it is resting (for example the floor) to a height which is above that of the platform support area 130. The robotic vehicle may then advance such that the platform can be lowered onto the platform support area 130 and such that the lifting shuttle 136 is received within the body of the robotic vehicle. An example of a robotic vehicle comprising such a lifting system is disclosed in the Applicant's co-pending international patent application PCT/EP2024/064402, the contents of which are hereby incorporated by reference.

The pallet 300 shown in FIG. 1 comprises a plurality of upper deck boards 302 on which a load may be received. The pallet also comprises a plurality of lower deck boards 304 which are in contact with the ground (or the surface upon which the pallet is resting). The upper deck boards 302 and the lower deck boards 304 are connected by a number of stringers, in this example two external stringers 308, which are located at the edge of the pallet, and one internal stringer 306. The combination of the upper deck boards, lower deck boards and the stringers define apertures 310 on opposed faces of the pallet into which the forks of a robotic vehicle can be inserted.

A robotic vehicle which can operate in an autonomous drive mode and which can be switched to operate in an assisted drive mode by the activation of a movable handle is disclosed in the Applicant's co-pending application WO2024/231519, the contents of which are hereby incorporated by reference.

### SUMMARY

According to a first aspect of the present disclosure, there is provided a robotic vehicle comprising a body; drive means for driving movement of the body; control means configured to control the movement of the body; a handle moveably coupled to the body; one or more cameras; and a display screen, wherein in use the activation of the handle causes the robotic vehicle to: i) switch from an autonomous drive mode to an assisted drive mode responsive to movement of the handle; and ii) display images from at least one of the one or more cameras on the display screen.

The display of the camera image(s) on the display screen enables a user to have a view which is not obscured by the body of the robotic vehicle or by a payload which is being carried by the robotic vehicle. This enables the user to move the robotic vehicle efficiently and when the robotic vehicle is being operated in the assisted drive mode. The risk of a collision with other objects is reduced as the view of the user is not compromised.

The robotic vehicle is further configured to overlay graphics on the camera images on the display screen. The overlaid graphics may be determined in accordance with one or more user inputs received from the handle. The overlaid graphics relate to the position and route of the robotic vehicle. The overlaid graphics may relate to the destination of the robotic vehicle. For example, the overlaid graphics may indicated the location at which a pallet may be deposited if the course of the robotic vehicle is maintained.

The overlaid graphics may indicate the speed of the robotic vehicle. The overlaid graphics may indicate the position of further objects. The further objects may comprise fixed objects such as shelving units, walls, picking stations, etc. which are received within the environment within which the robotic vehicle is operating. The further objects may also comprise mobile objects, for example other robotic vehicles (which may be operating in an autonomous drive mode or in an assisted drive mode), manually operated vehicles (for example a powered pallet truck or similar manual vehicle which can be used to move pallets), human users etc. The overlaid graphics may indicate an intended destination of the robotic vehicle. This enables a user of the robotic vehicle to steer the robotic such that it is moved to the intended destination in order to be able to perform a designated task.

The robotic vehicle may be further configured to generate a composite image from data received from a plurality of cameras and to display the composite image on the display screen. In one example, the images provided by two cameras which are facing the same direction are combined in order to provide a composite image. The composite image may comprise a stereoscopic image. In another example, images from multiple cameras, each of which may be facing in a different direction, are combined to generate a composite image showing the environment in the vicinity of the robotic vehicle. Such a composite image may comprise an overhead view of the robotic vehicle and any objects, hazards, etc which are near to it.

The body of the robotic vehicle may comprise a frame, wherein one or more cameras are received within the frame. The frame may comprise two substantially vertical elements which extend upwards from the body of the robotic vehicle and a substantially horizontal element which connects the two vertical elements. One or more of the cameras may be received within the horizontal element of the frame. In one example, the horizontal element of the frame may comprise four cameras. The four cameras may be arranged such that each of them is aligned with one of the faces of the robotic vehicle.

According to a second aspect of the present disclosure, there is provided computer implemented method for controlling the operation of a robotic vehicle, the robotic vehicle comprising a body, drive means for driving movement of the body; control means configured to control the movement of the body; a handle moveably coupled to the body; one or more cameras; and a display screen, the method comprising: the robotic vehicle operating in an autonomous drive mode; in response to detecting the movement of the handle from a first position to a second position, the robotic vehicle i) operating in an assisted drive mode; and ii) displaying images from at least one of the one or more cameras on the display screen.

According to a third aspect of the present disclosure, there is provided a non-transitory machine readable storage medium comprising machine-readable instructions that are to cause at least one processor circuit to operate a robotic vehicle in an autonomous drive mode, the robotic vehicle comprising a body, drive means for driving movement of the body; control means configured to control the movement of the body; a handle moveably coupled to the body; one or more cameras; and a display screen; in response to detecting the movement of the handle from a first position to a second position, i) operate the robotic vehicle in an assisted drive mode; and ii) display images from at least one of the one or more cameras on the display screen.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 shows a schematic depictions of a known robotic vehicle according to an example of the present disclosure;

FIGS. 2 and 3 show a schematic depiction of a robotic vehicle according to an example of the present disclosure;

FIG. 4 shows a graphical depiction of an image from a camera that may be displayed on the display screen of the robotic vehicle;

FIG. 5 shows a graphical depiction of a further image from a camera that may be displayed on the display screen of the robotic vehicle

FIG. 6 shows a schematic depiction of further aspects of the robotic vehicle according to the present disclosure;

FIG. 7 shows a schematic depiction of a method according to the present disclosure; and

FIG. 8 shows a schematic depiction of a computer device which may be comprised within the robotic vehicle

### DETAILED DESCRIPTION

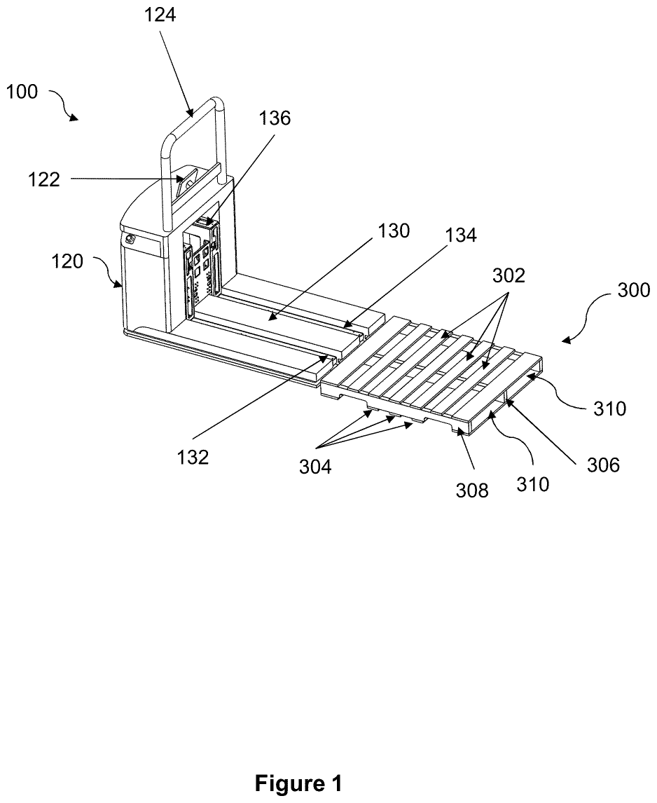

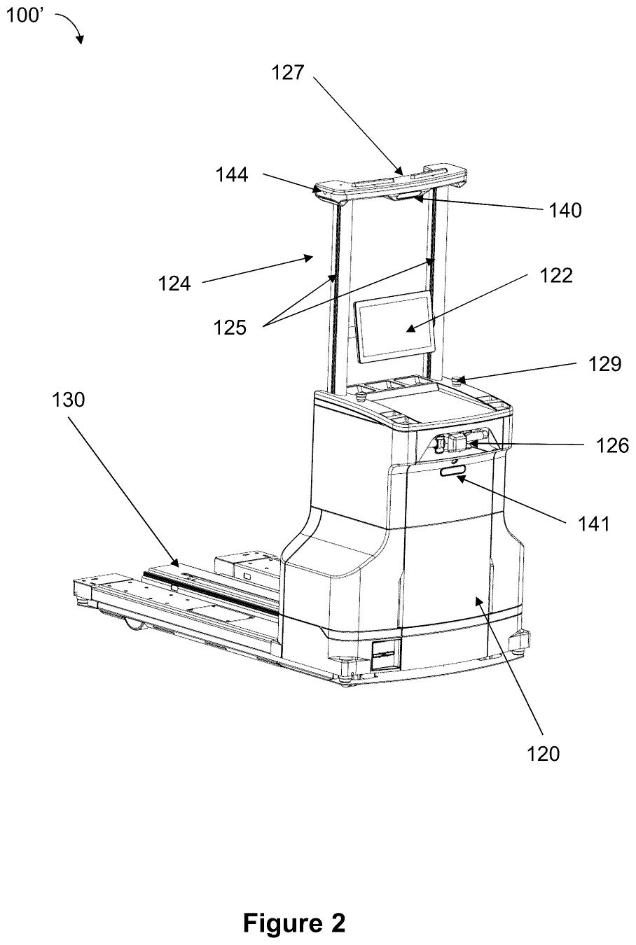

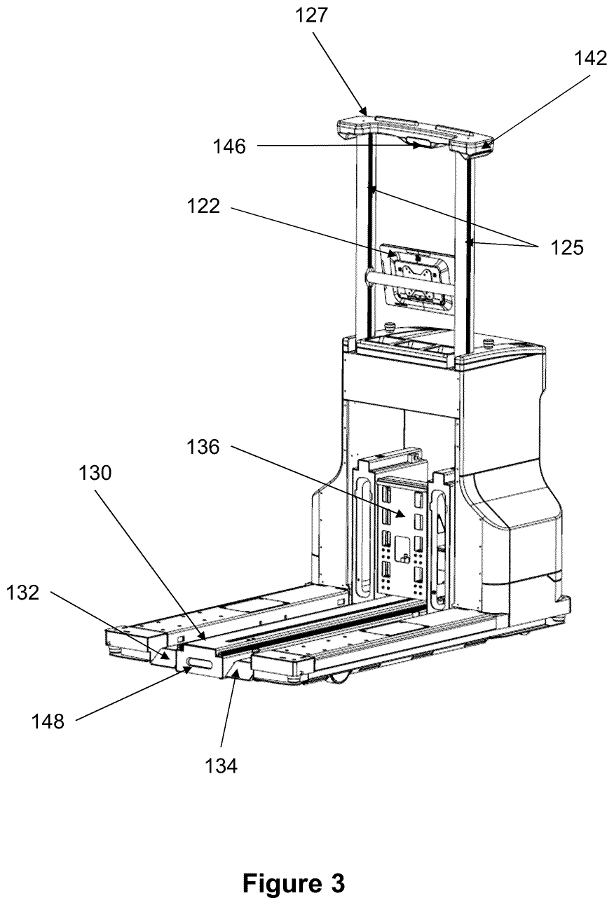

FIGS. 2 and 3 show a schematic depiction of a robotic vehicle 100′ according to an example of the present disclosure. The robotic vehicle 100′ shown in FIGS. 2 and 3 is functionally similar to the robotic vehicle 100 described above with reference to FIG. 1. The robotic vehicle comprises a body 120, upper frame 124 and a movable handle 126. The movable handle is normally in a stowed position but can be moved from the stowed position to an extended position such that a user can control the movement of the robotic vehicle (see below).

The upper frame 124 comprises two vertical members 125, which are connected with a horizontal member 127. The display screen may be mounted to the two vertical members 125, or may alternatively be mounted to another part of the body. The robotic vehicle further comprises a platform support area 130 which is located at the rear of the robotic vehicle. The robotic vehicle further comprises a lifting shuttle 136 which is coupled to a first fork 132 and second fork 134. In operation, the lifting shuttle can be advanced from the body of the robotic vehicle, such that the first fork 132 and the second fork 134 are advanced from underneath the platform support area 130.

The robotic vehicle may operate in an autonomous driving mode, using cameras and/or other sensors to navigate through a storage environment, such as, for example a warehouse. The robotic vehicle may move to a first location, retrieve a pallet, store it on the robotic vehicle, move to a further location and then deposit the pallet such that one or more users may process one or more boxes or containers which are held on the pallet. In some instances, it may be necessary for a human user to operate the robotic vehicle. A user may extend the movable handle, which then causes the robotic vehicle to exit the autonomous driving mode. The user may then manipulate the handle to control the movement of the robotic vehicle. The robotic vehicle may comprise additional controls 129 such that a user can operate the lift mechanism, sound a horn to send a warning etc. An example of a robotic vehicle which can operate in either an autonomous driving mode or an assisted drive mode can be found in WO2024/231519, the contents of which are hereby incorporated by reference.

The robotic vehicle further comprises one or more cameras. These cameras may be used by the robotic vehicle to determine its location within a storage environment, detect potential obstacles, manoeuvre through the storage environment, etc. Data obtained from the one or more cameras may be complemented by data obtained from lidar sensors or other sensors. In the example shown in FIGS. 2 and 3, the robotic vehicle comprises a plurality of cameras, specifically front camera 140, lower front camera 141, right-hand camera 144, left hand camera 142, rear camera 146 and support area camera 148. It should be understood that the robotic vehicle may comprise more or fewer cameras and that they may be located elsewhere within the robotic vehicle.

When the robotic vehicle is operating in the autonomous driving mode then it moves such that the body of the robotic vehicle is to the front and the platform support area is to the rear. Thus, in the autonomous driving mode the front camera 140 is facing in the forward direction, the rear camera 146 is facing in the rearward direction and the right-hand camera 144 and the left hand camera 142 are facing right and left respectively. When a user is operating the robotic vehicle in the assisted drive mode then it is likely that the user will cause the robotic vehicle to move in the reverse direction when compared with the operation of the robotic vehicle in the autonomous drive mode. It should be understood that the lower front camera 141 is not used when a user is operating a vehicle in the assisted drive mode as the user will be obstructing the view of the lower front camera when they are manipulating the movable handle.

As discussed above, the extension of the movable handle causes the robotic vehicle to enter the assisted drive mode. Furthermore, the extension of the movable handle causes images from one or more of the cameras to be displayed on the display screen of the robotic vehicle. In one example, the images are presented as video stream. It can be seen that the body 120 blocks the user's view of the end of the platform support area 130. Furthermore, if the load stored on a pallet which is received on the platform support area is particularly high then this may further restrict the view of the user of the robotic vehicle. For example, the maximum height of the payload received on a pallet may be 2.3 m (90 inches) The use of one or more cameras to provide a view on the display screen may mitigate the risk of a collision due to the user being unsighted.

The images displayed on the screen enables the user to steer and move the robotic vehicle in the assisted drive mode with increased visibility, such that the user may move the robotic vehicle to an intended destination and then perform a task, for example load a pallet onto or unload a pallet from the robotic vehicle. The images displayed to the user allow the user to avoid collision with other vehicles, users or objects which are received within the environment that the robotic vehicle is being operated.

In a first example, the images from the support area camera 148 are displayed on the display screen. The position of the support area camera below the level of the pallet and the load received on the platform support area should provide an uninterrupted view of the space in front of the robotic platform when it is being operated in the assisted drive mode. In a second example, the images from the rear camera 146 are displayed on the display screen. The position of the rear camera on the upper frame 124 enables the rear camera to see over all but the highest loads that are received on the platform support area of the robotic vehicle. In a third example, the images from the support area camera and the rear camera can be processed to form a stereoscopic image, such that the user has increased depth perception of any objects that might be in the path of the robotic vehicle.

In another example, the images of multiple cameras may be combined to generate a top-down or birds-eye view of the area around the robotic vehicle, showing any obstacles, people, vehicles etc which are near to the robotic vehicle. In one example the overhead view is generated using the four cameras located in the upper frame of the robotic vehicle, that is the front camera 14, the right-hand camera 144, the left hand camera 142 and the rear camera 146.

It should be understood that images from multiple cameras may be displayed on the screen at the same time. Each image may be displayed using substantially the same amount of screen space. In an alternative, the images may be provided in a picture-in-picture format. The robotic vehicle may use its sensing capabilities to determine which camera view is the most informative for the user, with the other camera image streams being shown in a thumbnail view. As potential hazards or obstructions are detected, the robotic vehicle may change the camera image which is the main image, or re-configure the displayed images in some other manner to indicate any potential risk. In one example, a user may use the controls 129 to select the camera(s) which are used to display images on the display screen.

Notwithstanding the camera (or cameras) which are used to display images to a user via the display screen, it should be understood that the robotic vehicle may overlay graphics or other information onto the images. For example, if a potential hazard or obstruction are detected, it may be highlighted graphically in some manner. Additionally, or in the alternative, some form of audible alarm may also be generated. Specifically, the robotic vehicle may detect the presence of powered pump trucks and in addition to showing them in the images displayed on the display screen may overlay visual cues and/or warnings to alert the user of the robotic vehicle/

The predicted path of the robotic vehicle may be overlaid on the images generated from the camera. The predicted path of the robotic vehicle may be determined in accordance with the inputs being provided by the user via the handle and then overlaid over the image(s) from the camera(s). For example, if the user is turning the handle then the turning path of the robotic vehicle will be indicated. The destination of the vehicle based on present inputs may also be displayed to the user using the display screen, such that the user is aided in their navigation of the robotic vehicle.

The display screen may also indicate an intended location for the robotic vehicle, for example a specified location within a storage environment where the robotic vehicle is to deposit a pallet. The display screen may further suggest a route for the user to take to reach the intended location. If the task assigned to the robotic vehicle is the retrieval of a pallet from a location then the graphics overlaid on the display may include markers to assist the user in manoeuvring the robotic vehicle relative to the pallet to be retrieved. These markers may provide information relating to the orientation and/or the position of the robotic vehicle relative to the pallet to be retrieved.

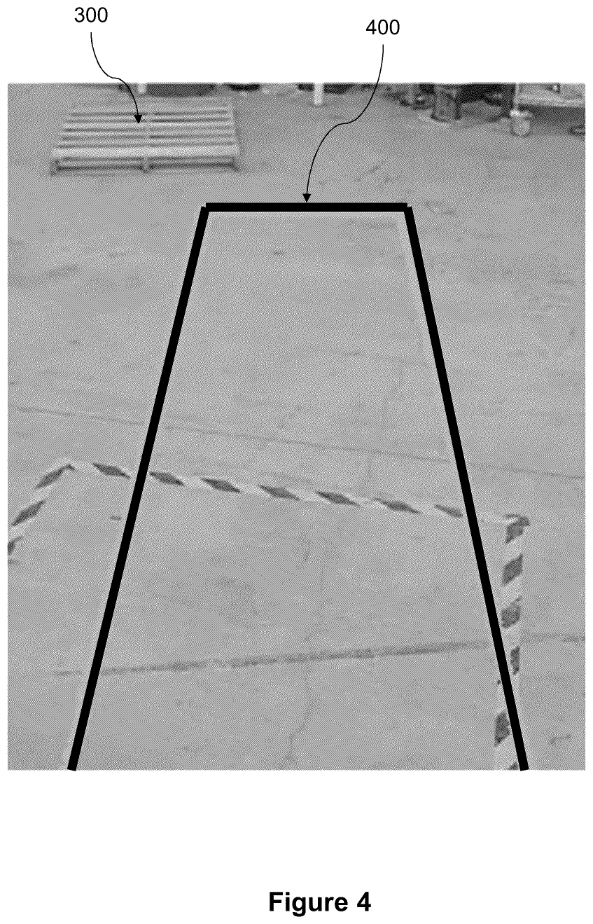

FIG. 4 shows a graphical depiction of an image from a camera that may be displayed on the display screen of the robotic vehicle. The robotic vehicle is approaching a pallet 300 and the predicted path 400 of the robotic vehicle is overlaid on the image. It can be seen from FIG. 4 that the user is not turning the handle of the robotic vehicle as the predicted path is straight ahead of the robotic vehicle.

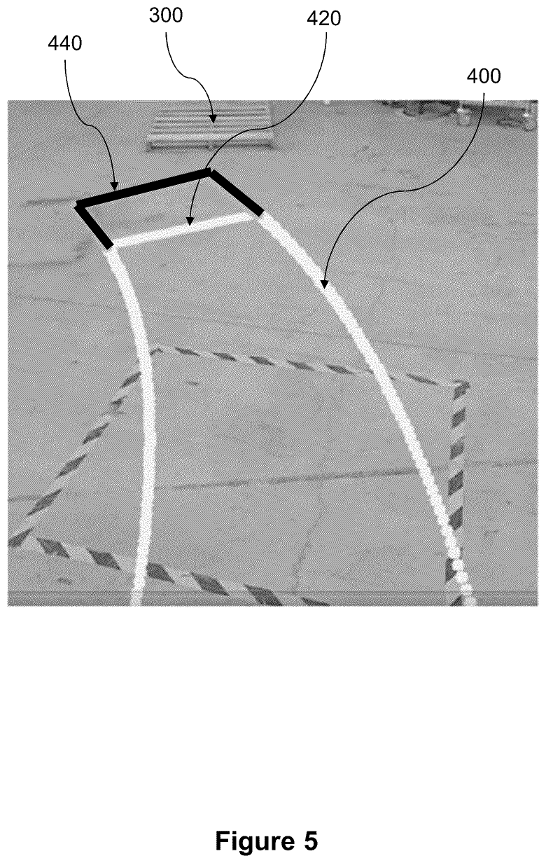

FIG. 5 shows a graphical depiction of a further image from a camera that may be displayed on the display screen of the robotic vehicle. The robotic vehicle is approaching a pallet 300 and the predicted path 400 of the robotic vehicle is overlaid on the image. In FIG. 5 it can be seen from the predicted path that the user is now turning the handle of the robotic vehicle such that the robotic vehicle turns to the left. The predicted path comprises elements shown in white 400 420 which show the path that the robotic vehicle would take if it would slow down immediately. The extension to the path shown in black 440 shows is an extended path to show the long term position of the robotic vehicle if it were to keep the same speed.

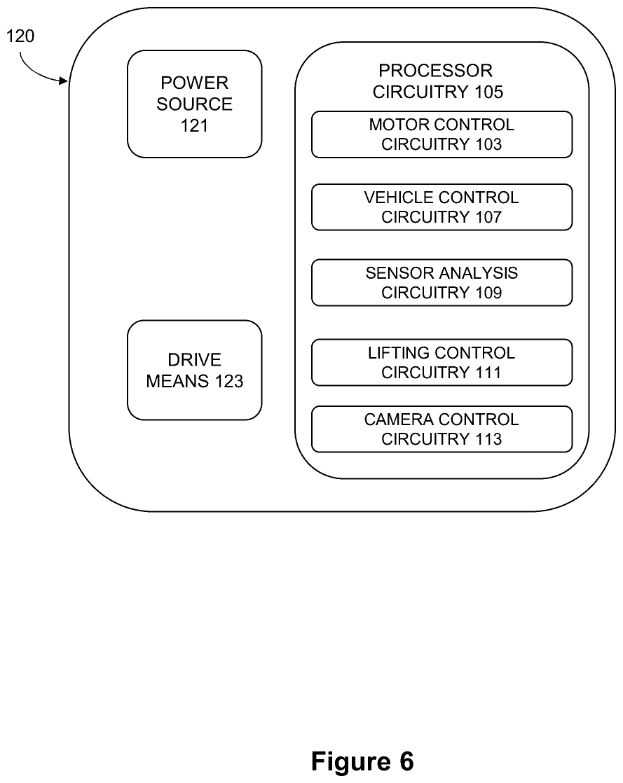

FIG. 6 shows a schematic depiction of further aspects of the robotic vehicle 100′ according to the present disclosure that are not described above with reference to FIGS. 2 & 3. The example robotic vehicle 100 comprises a body 120 and a drive means 121 which may comprise one or more motors (e.g. electric motor(s) and/or other drive mechanism(s)) to cause movement of the body 120 via wheel(s) of the robotic vehicle 100. The robotic vehicle 100 includes motor control circuitry 103 (e.g. hardware and/or software components) to control, for example, the speed of the robotic vehicle 100. One or more components of the motor control circuitry 103 can be implemented by processor circuitry 105 of the vehicle 100.

The robotic vehicle 100 includes vehicle control circuitry 107 to control movement of the autonomous or self-driving robotic vehicle 100. One or more components of vehicle control circuitry 107 can be implemented by the processor circuitry 105 of the robotic vehicle 100, processor circuitry of another user device, and/or cloud-based device(s). The robotic vehicle 100 can move to a location in a storage environment without or with limited user input control during movement of the vehicle 100. Such movement may be controlled in accordance with data received from sensor analysis circuitry 109. The sensors may comprise lidar sensors, ultrasonic sensors, the one or more cameras, etc. The lifting control circuitry 111 controls the movement of the forks, for example into and out of the interior of a platform and the vertical movement of the forks to lift or lower the forks (and a platform received on the forks). The camera control circuitry 113 may control the images fed to the display screen when the robotic vehicle is being operated in the assisted drive mode. The camera control circuitry may determine which camera (or cameras) should be used to send images to the display screen and what additional data, if any, should be overlaid on the display screen. The camera control circuitry may be responsive to the controls 129 such that a user is able to control the images being displayed on the display screen.

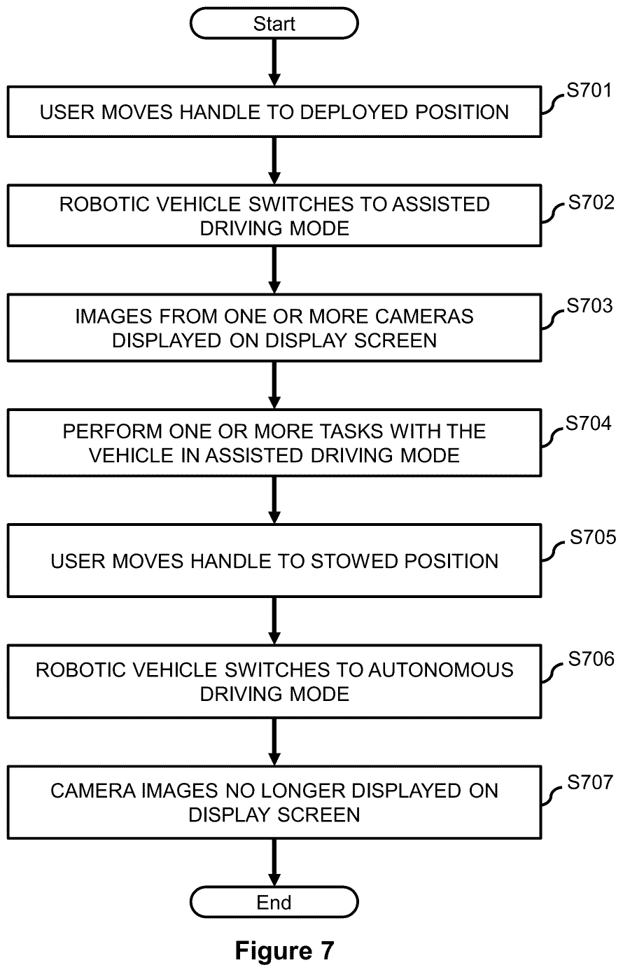

FIG. 7 shows a schematic depiction of a method according to the present disclosure. The method starts at S701, when a user moves the handle from the stowed position to the deployed position. The movement of the handle causes the robotic vehicle to switch from the autonomous drive mode to the assisted drive mode (S702) and then the images from one or more cameras are displayed on the display screen of the robotic vehicle (S703). The user will then operate the robotic vehicle in the assisted drive mode to perform one or more tasks that have been assigned to the user and the robotic vehicle (S704). Once these tasks have been completed then the user may move the handle into the stowed position (S705). A visual prompt may be displayed on the display screen of the robotic screen to indicate to the user that the handle may be stowed. The movement of the handle into the stowed position causes the robotic vehicle to switch from the assisted drive mode to the autonomous drive mode (S706). As the robotic vehicle is no longer operating in the assisted drive mode then the camera images can be removed from the display screen (S707) and the method then terminates. It will be understood that the method can be instantiated again when the handle is moved from the stowed position to the deployed position.

It should be understood that the ordering of the method may be varied without departing from the teaching of the present disclosure. For example, when the handle is moved to the deployed position at S701 then the switch to the assisted driving mode (S702) and the display of the camera image(s) (S703) may occur simultaneously. Alternatively, the camera image(s) (S703) may be displayed on the display screen before the robotic vehicle switches from the autonomous drive mode to the assisted drive mode (S702). Similarly, the movement of the handle to the stowed position may cause the robotic vehicle to switch to the autonomous drive mode (S706) at substantially the same time that the camera image(s) are no longer displayed on the display screen (S707). Alternatively, the camera image(s) may no longer be displayed on the display screen (S707) before the robotic vehicle switches from the assisted drive mode to the autonomous drive mode (S706).

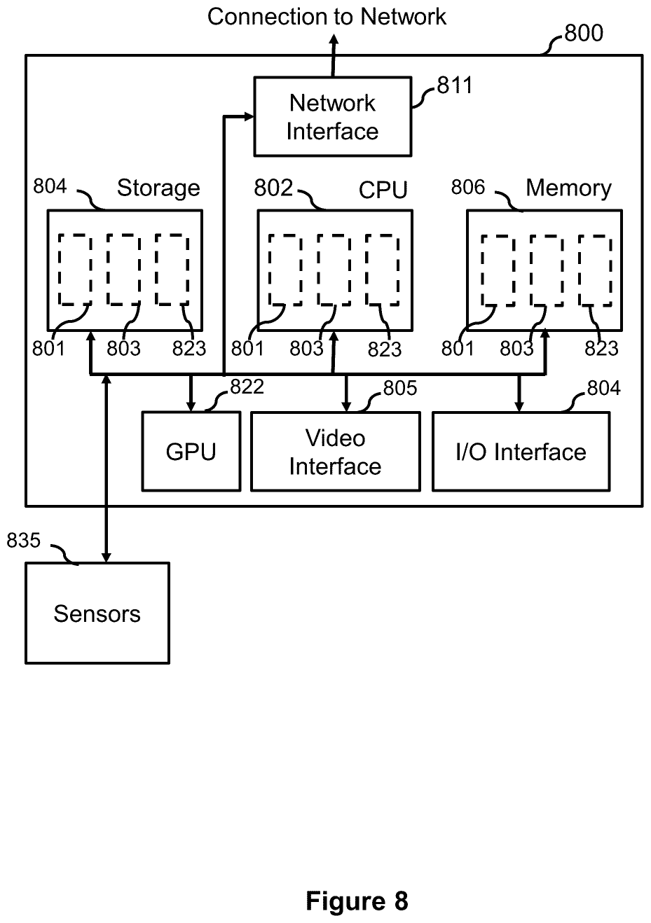

It will be understood that a robotic vehicle according to the present disclosure may comprise one or more computing devices, for example for instantiating the processor circuitry 105. FIG. 8 shows a schematic depiction of a computer device 800 that may include a central processing unit (“CPU”) 802 connected to a storage unit 814 and to a random access memory 806. The CPU 802 may process an operating system 801, application program 803, and data 823. The operating system 801, application program 803, and data 823 may be stored in storage unit 814 and loaded into memory 806, as may be required. Computer device 800 may further include a graphics processing unit (GPU) 822 which is operatively connected to CPU 802 and to memory 806 to offload intensive image processing calculations from CPU 802 and run these calculations in parallel with CPU 802. The computing device may further comprise a network interface 811, for example a WiFi interface or a cellular interface (for example, an interface using LTE technology), to communicate with a warehouse management system and/or other systems operating in the storage environment in which the robotic vehicle operates. The computer device 800 may receive data from one or more sensors 835. These sensors may comprise the one or more cameras received within the robotic vehicle, and any other sensors which may be comprised within the robotic vehicle. Data generated by one or more further sensors may also be received by the computer device and used to control the movement and operation of the robotic vehicle.

In one respect, there is provided a robotic vehicle which can operate in an autonomous mode. The robotic vehicle may be switched into an assisted drive mode, for example by the activation of a handle. When the robotic vehicle is in the assisted drive mode then images from one or more cameras comprised within the robotic vehicle may be displayed on a robotic vehicle display screen.

1. A robotic vehicle comprising:
a body;
drive means for driving movement of the body;
control means configured to control the movement of the body;
a handle moveably coupled to the body;
one or more cameras; and
a display screen, wherein in use the activation of the handle causes the robotic vehicle to:
i) switch from an autonomous drive mode to an assisted drive mode responsive to movement of the handle; and
ii) display images from at least one of the one or more cameras on the display screen.

2. A robotic vehicle according to claim 1, wherein the robotic vehicle is further configured to overlay graphics on the camera images on the display screen.

3. A robotic vehicle according to claim 2, wherein the overlaid graphics are determined in accordance with one or more user inputs received from the handle.

4. A robotic vehicle according to claim 2, wherein the overlaid graphics relate to the position and route of the robotic vehicle.

5. A robotic vehicle according to claim 2, wherein the overlaid graphics relate to the destination of the robotic vehicle.

6. A robotic vehicle according to claim 2, wherein the overlaid graphics indicate the speed of the robotic vehicle.

7. A robotic vehicle according to claim 2, wherein the overlaid graphics indicate the position of further objects.

8. A robotic vehicle according to claim 2, wherein the overlaid graphics indicate an intended destination of the robotic vehicle.

9. A robotic vehicle according to claim 1, wherein the robotic vehicle is further configured to generate a composite image from data received from a plurality of cameras and to display the composite image on the display screen.

10. A robotic vehicle according to claim 1, wherein the body comprises a frame, wherein one or more cameras are received within the frame.

11. A robotic vehicle according to claim 10, wherein the frame comprises two substantially vertical elements which extend upwards from the body of the robotic vehicle and a substantially horizontal element which connects the two vertical elements.

12. A robotic vehicle according to claim 11, wherein one or more of the cameras are received within the horizontal element of the frame.

13. A computer implemented method for controlling the operation of a robotic vehicle, the robotic vehicle comprising a body, drive means for driving movement of the body; control means configured to control the movement of the body; a handle moveably coupled to the body; one or more cameras; and a display screen, the method comprising:
the robotic vehicle operating in an autonomous drive mode;
in response to detecting the movement of the handle from a first position to a second position, the robotic vehicle
i) operating in an assisted drive mode; and
ii) displaying images from at least one of the one or more cameras on the display screen.

14. A non-transitory machine readable storage medium comprising machine-readable instructions that are to cause at least one processor circuit to:
operate a robotic vehicle in an autonomous drive mode, the robotic vehicle comprising a body, drive means for driving movement of the body; control means configured to control the movement of the body; a handle moveably coupled to the body; one or more cameras; and a display screen;
in response to detecting the movement of the handle from a first position to a second position,
i) operate the robotic vehicle in an assisted drive mode; and
ii) display images from at least one of the one or more cameras on the display screen.
